(19) United States
(12) Patent Application Publication
(10) Pub. No.: US 2007/0152525 A1
(43) Pub. Date: Jul. 5, 2007

(54) Rotor rotational structure for motor

(75) Inventors: Alex Horng, Kaohsiung (TW); Yin-Rong Hong, Kaohsiung (TW)

Correspondence Address: BIRCH STEWART KOLASCH & BIRCH, PO BOX 747, FALLS CHURCH, VA, 22040-0747, US

(73) Assignee: Sunonwealth Electric Machine Industry Co., Ltd.

(21) Appl. No.: 11/432,364

(22) Filed: May 12, 2006

(30) Foreign Application Priority Data
Dec. 30, 2005 (TW) 094147452

(51) Int. Cl. H02K 5/16

(52) U.S. Cl. 310/90

(57) ABSTRACT

A rotor rotational structure for a motor includes a shaft, an axial tube having a closed bottom end, a self-lubricating bearing mounted in the axial tube; and a retaining member mounted in the axial tube and between the closed bottom end of the axial tube and the self-lubricating sleeve. A first end of the shaft is fixed to a center of a rotor. A second end of the shaft includes an abutting portion on an outer end thereof. The shaft further includes an annular groove in a section adjacent to the abutting portion. The retaining member is a substantially hollow cylindrical member. An end of the retaining member that faces the self-lubricating bearing extends radially outward to form an axial hole having a minimum diameter smaller than a maximum diameter of the shaft, thereby being retained in the annular groove of the shaft.

### BACKGROUND OF THE INVENTION

1. Field of the Invention

The present invention relates to a rotor rotational structure for a motor. More particularly, the present invention relates to a rotor rotational structure for a motor that provides a space for receiving an abutting portion of a shaft and that provides a rotational retaining effect for the shaft.

2. Description of Related Art

Taiwan Utility Model Application No. 89203147 discloses an improved stator structure for a heat-dissipating fan. The heat-dissipating fan includes a casing, a circuit board, a stator, a retaining plate, a self-lubricating bearing and an impeller. The casing defines a central receiving compartment in which a seat is formed, and an axial tube is fixed to the seat.

The axial tube of the stator is a hollow cylindrical member and includes a closed bottom end. An arcuate recessed portion protrudes downward from a center of the bottom end. The retaining plate, after placed into the axial tube, is located above the arcuate recessed portion. The self-lubricating bearing and the bottom end of the axial tube sandwich the retaining plate in place. A shaft of the impeller is extended through the self-lubricating bearing and then forcibly extended through and retained by the retaining plate. Rapid assembly is accomplished without any tool.

However, the above design saves the material cost at the cost of difficulty to and increased cost of manufacturing. More specifically, the axial tube with an arcuate recessed portion on the bottom end could not be obtained through automatic production with currently available machines such that an additional punching die device is required. Further, a yoke is provided on top of the axial tube such that the punching die device must include punching dies for punching, cutting, and bending for automatic production. The punching die device is thus complicated and the manufacturing cost is increased accordingly.

### SUMMARY OF THE INVENTION

A rotor rotational structure for a motor in accordance with the present invention comprises a shaft, an axial tube having a closed bottom end, a self-lubricating bearing mounted in the axial tube; and a retaining member mounted in the axial tube and between the closed bottom end of the axial tube and the self-lubricating sleeve. A first end of the shaft is fixed to a center of a rotor. A second end of the shaft includes an abutting portion on an outer end thereof. The shaft further includes an annular groove in a section adjacent to the abutting portion. The retaining member is a substantially hollow cylindrical member. An end of the retaining member that faces the self-lubricating bearing extends radially outward to form an axial hole having a minimum diameter smaller than a maximum diameter of the shaft, thereby being retained in the annular groove of the shaft.

Preferably, the end of the retaining member includes a plurality of retaining plates extending radially inward. The retaining plates are retained in the annular groove of the shaft.

The axial tube may be fixed to a seat. Alternatively, the axial tube is integrally formed with a seat.

The self-lubricating bearing may be in loose or tight fit with an inner circumferential wall of the axial tube in tolerance.

Preferably, a positioning ring is mounted on top of the self-lubricating bearing for positioning.

Preferably, a padding member is mounted below the retaining member. The abutting portion of the shaft abuts against the padding member.

Preferably, the padding member is made of abrasion-resistant resilient material.

The retaining member in rotor structure in accordance with the present invention provides a space for receiving the abutting portion of the shaft and provides a rotational retaining effect for the shaft. Further, the retaining member may receive and preserve lubricating oil while allowing easy assembly. The number of components is reduced, and the assembling procedures are simplified. The retaining member also allows production of the axial tubes of certain specifications without the need of expensive automated die devices. The manufacturing cost is reduced.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view illustrating a motor with a first embodiment of a rotor rotational structure in accordance with the present invention;

FIG. 2 is a sectional view of the motor in FIG. 1;

FIG. 3 is a sectional view similar to FIG. 2, illustrating a second embodiment of the rotor rotational structure in accordance with the present invention;

FIG. 4 is an exploded sectional view illustrating a motor with a third embodiment of the rotor rotational structure in accordance with the present invention; and

FIG. 5 is a sectional view of the motor in FIG. 4.

### DETAILED DESCRIPTION OF THE PREFERRED EMBODIMENTS

A motor includes a rotor and a stator, with a shaft provided to a center of the rotor. The present invention is featured in the rotational retaining arrangement for the shaft. Detailed structures of the rotor and the stator are not described to avoid redundancy, as they are conventional and not the features of the present invention.

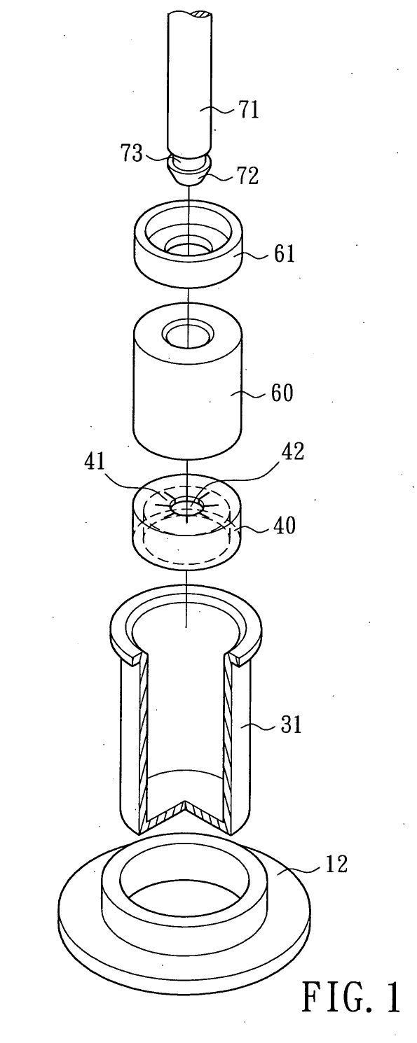

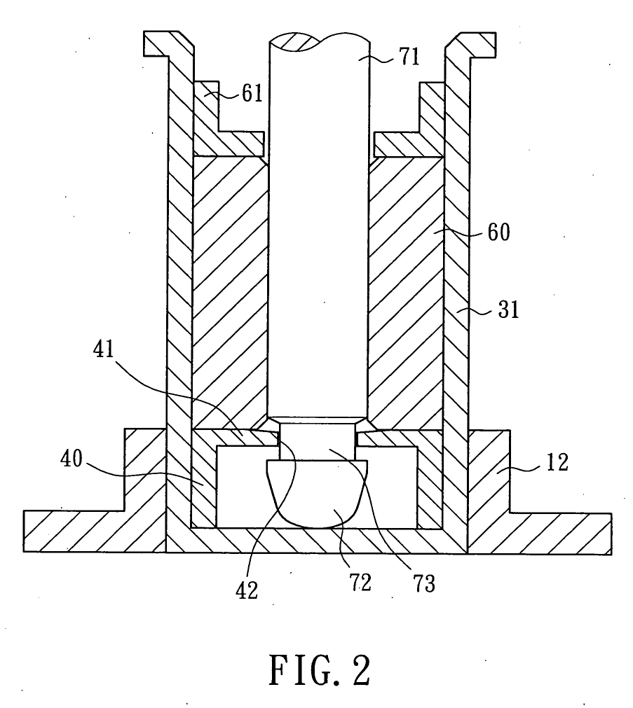

Referring to FIGS. 1 and 2, in a first embodiment of the present invention, a shaft 71 of the rotor includes an abutting portion 72 on an outer end thereof, and an annular groove 73 is defined in a circumference of the shaft 71 in a section adjacent to the abutting portion 72.

The stator includes an axial tube 31 fixed to a seat 12. The axial tube 31 is substantially a hollow cylindrical member with a closed bottom end. A retaining member 40 and a self-lubricating bearing 60 are placed into the axial tube 31 in sequence, and a positioning ring 61 is mounted into the axial tube 31 for retaining the self-lubricating bearing 60 and the retaining member 40 in the axial tube 31.

The retaining member 40 is a hollow cylindrical member having a longitudinal through-hole. A plurality of retaining plates 41 extend radially inward from an end of the retaining member 40 that faces the self-lubricating bearing 60. The retaining plates 41 define an axial hole 42 having a minimum diameter smaller than the maximum diameter of the shaft 71, allowing coupling with the annular groove 73 of the shaft 71.

After the shaft 71 of the rotor is extended through the self-lubricating bearing 60, the abutting portion 72 is forcibly passed through the axial hole 42 defined by the retaining plates 41 into the retaining member 40. The retaining plates 41 are retained in the annular groove 73 of the shaft 71, preventing disengagement of the rotor during rotation.

The retaining member 40 has a length for receiving the abutting portion 72 of the shaft 71 while providing the required rotational retaining effect for the shaft 71. The number of components is reduced, the assembling procedures are simplified, and the manufacturing cost is reduced.

The self-lubricating bearing 60 is in loose fit with an inner circumferential wall of the axial tube 31 in tolerance in the first embodiment (see FIG. 2). Hence, a positioning ring 61 must be placed on top of the self-lubricating bearing 60.

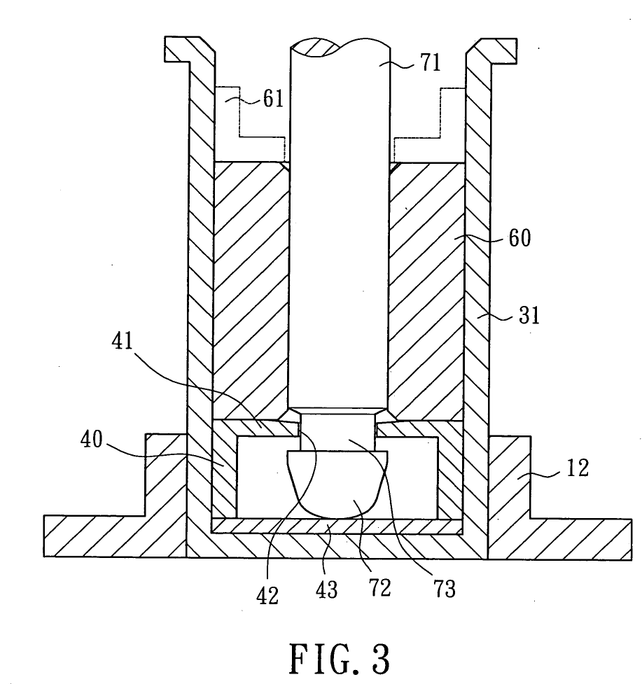

In a second embodiment shown in FIG. 3, the self-lubricating bearing 60 is in tight fit with the inner circumferential wall of the axial tube 31 in tolerance. The positioning ring 61 can be omitted to further save the cost.

Further, a padding member 43 can be mounted in the axial tube 31 before mounting the retaining member 40 and the self-lubricating bearing 60. The padding member 43 is made of abrasion-resistant resilient material. The abutting portion 72 of the shaft 71 abuts against the padding member 43. Hence, the shaft 71 is cushioned and protected during rotation.

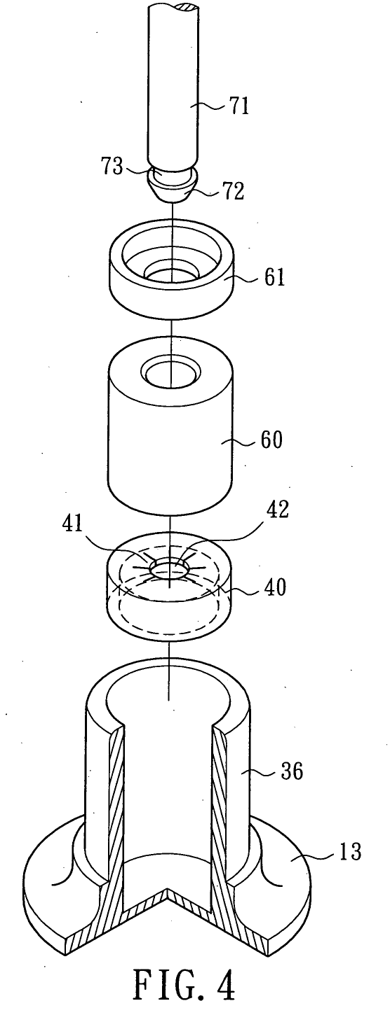

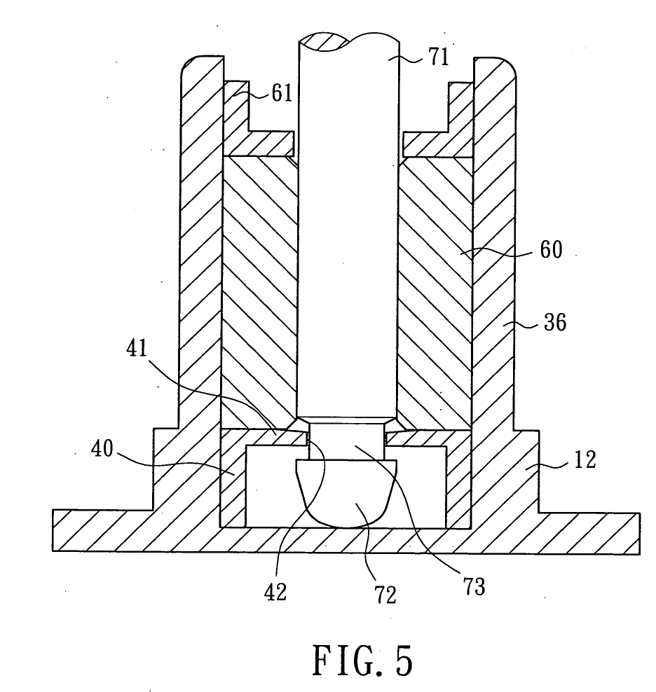

FIGS. 4 and 5 illustrate a third embodiment of the invention, wherein the axial tube 36 and the seat 12 are made as an integral member. More specifically, the axial tube 36 extends upward from the seat 12 to form a hollow cylindrical member with a closed bottom end. Similar to the above embodiments, after the shaft 71 of the rotor is extended through the self-lubricating bearing 60, the abutting portion 72 is forcibly passed through the axial hole 42 defined by the retaining plates 41 into the retaining member 40. The retaining plates 41 are retained in the annular groove 73 of the shaft 71, preventing disengagement of the rotor during rotation.

The retaining member 40 in rotor structure in accordance with the present invention provides a space for receiving the abutting portion 72 of the shaft 71 and provides a rotational retaining effect for the shaft 71. Further, the retaining member 40 may receive and preserve lubricating oil while allowing easy assembly. The number of components is reduced, and the assembling procedures are simplified. The retaining member 40 also allows production of the axial tubes 31 and 36 of certain specifications without the need of expensive automated die devices. The manufacturing cost is reduced.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A rotor rotational structure for a motor, comprising:
a shaft fixed to a center of a rotor, the shaft including an abutting portion on an end thereof, the shaft further including an annular groove in a section adjacent to the abutting portion;
an axial tube having a closed bottom end;
a self-lubricating bearing mounted in the axial tube; and
a retaining member mounted in the axial tube and between the closed bottom end of the axial tube and the self-lubricating sleeve, the retaining member being a substantially hollow cylindrical member, an end of the retaining member that faces the self-lubricating bearing extending radially outward to form an axial hole having a minimum diameter smaller than a maximum diameter of the shaft, thereby being retained in the annular groove of the shaft.

2. The rotor rotational structure for a motor as claimed in claim 1 wherein the end of the retaining member includes a plurality of retaining plates extending radially inward, the retaining plates being retained in the annular groove of the shaft.

3. The rotor rotational structure for a motor as claimed in claim 1 wherein the axial tube is adapted to be fixed to a seat.

4. The rotor rotational structure for a motor as claimed in claim 1 wherein the axial tube is adapted to be integrally formed with a seat.

5. The rotor rotational structure for a motor as claimed in claim 1 wherein the self-lubricating bearing is in loose fit with an inner circumferential wall of the axial tube in tolerance.

6. The rotor rotational structure for a motor as claimed in claim 1 wherein the self-lubricating bearing is in tight fit with an inner circumferential wall of the axial tube in tolerance.

7. The rotor rotational structure for a motor as claimed in claim 1 further comprising a positioning ring mounted on top of the self-lubricating bearing for positioning.

8. The rotor rotational structure for a motor as claimed in claim 1 further comprising a padding member mounted below the retaining member, the abutting portion of the shaft abutting against the padding member.

9. The rotor rotational structure for a motor as claimed in claim 8 wherein the padding member is made of abrasion-resistant resilient material.
